(19) United States
(12) Patent Application Publication
(10) Pub. No.: US 2013/0118977 A1
(43) Pub. Date: May 16, 2013

(54) Process and Apparatus for Gas-Enriching a Liquid

(71) Applicant: Blissfield Manufacturing Company, (US)

(72) Inventors: Bruce A. Eppink, Sylvania, OH (US); Mark J. Golba, Sylvania, OH (US); Mark A. Conrad, Britton, MI (US)

(73) Assignee: Blissfield Manufacturing Company

(21) Appl. No.: 13/674,708

(22) Filed: Nov. 12, 2012

Related U.S. Application Data
(60) Provisional application No. 61/558,260, filed on Nov. 10, 2011.

(51) Int. Cl. C02F 1/00

(52) U.S. Cl. CPC C02F 1/006
USPC 210/620; 261/65; 210/749; 210/758

(57) ABSTRACT

Methods and apparatuses are described for enriching a first liquid with a gas and introducing the gas-enriched first liquid into a second liquid. In an embodiment, the apparatus comprises a vessel containing the gas at an elevated pressure, a liquid fluid inlet into the vessel such that the first liquid enters the vessel and becomes enriched with the gas, a variable internal valve defining an opening through which the gas-enriched first liquid flows after exiting the vessel, the internal valve opening adapted to generate bubbles of the gas within the gas-enriched first liquid as the gas-enriched first liquid flows therethrough, and a tube through which the gas-enriched first liquid flows into the second liquid, the tube comprising an inlet section comprising an inlet, a coiled section fluidically coupled to the inlet section, an outlet section fluidically coupled to the coiled section, and an outlet fluidically coupled to the outlet section, the tube adapted to maintain the bubbles of the oxygen-containing gas generated within the gas-enriched first liquid by the valve means.

### BACKGROUND

This disclosure generally relates to fluid treatment apparatuses, and more particularly to a process and apparatus capable of enriching a liquid with a gas and introducing the gas-enriched liquid into a second liquid.

Systems are known that make use of liquids enriched with a gas. For example, U.S. Pat. No. 2,713,026 to Kelly et al. appears to disclose the use of a gas-enriched fluid for wastewater treatment, and in particular the introduction of an air-supersaturated fluid into a pool of wastewater to suspend solids in the wastewater and facilitate their removal. Another example is U.S. Pat. No. 4,192,742 to Bernard et al., which appears to teach that the biodegradation of wastewater can be promoted by treating the wastewater within a treatment chamber maintained at a pressure above atmospheric pressure to achieve super oxygenation of the wastewater.

Methods and equipment for enriching a liquid with a gas are also known. For example, U.S. Pat. No. 3,957,585 to Malick appears to disclose that atomized liquid can be introduced into a reaction zone to effect intimate contact of the atomized liquid with a gas phase. A particular type of atomizing spray head for this purpose is disclosed in U.S. patent application Ser. No. 13/602,793 to Eppink et al., filed Sep. 4, 2012, whose contents are fully incorporated herein by reference (“Eppink”). As explained in Eppink et al., such spray heads are adapted to introduce an atomized fluid (for example, potable water or sewage water) into a chamber containing oxygen at a high pressure, with the result that the fluid becomes saturated with oxygen. The oxygen-saturated fluid can then be introduced into a stream of wastewater with the result that the wastewater contains sufficiently high levels of oxygen to promote the activity of aerobic microorganisms capable of biodegrading waste in the wastewater.

U.S. Pat. Nos. 7,008,535 and 7,294,278, each to Spears et al., appear to disclose that a gas-supersaturated fluid can be introduced into a wastewater so that the gas-supersaturated liquid is introduced in a substantially bubble-free manner. For this purpose, Spears et al. discloses the use of one or more fluid exit nozzles containing capillaries through which the gas-supersaturated liquid can be injected into the wastewater. U.S. Pat. No. 7,294,278 to Spears et al. discloses capillaries having diameters of about 150 to about 450 micrometers in nozzles having a plate-like construction, and capillary diameters of about 0.005 inch (about 125 micrometers) in nozzles having a more conventional spray head-type configuration. A drawback of the capillaries is that they may be prone to becoming plugged by solids and reaction products that may be entrained within the gas-supersaturated fluid.

### SUMMARY

Methods and apparatuses are described for enriching a first liquid with a gas and introducing the gas-enriched first liquid into a second liquid. In an embodiment, the apparatus comprises a vessel containing the gas at an elevated pressure, a liquid fluid inlet into the vessel such that the first liquid enters the vessel and becomes enriched with the gas, a variable internal valve defining an opening through which the gas-enriched first liquid flows after exiting the vessel, the internal valve opening adapted to generate bubbles of the gas within the gas-enriched first liquid as the gas-enriched first liquid flows therethrough, and a tube through which the gas-enriched first liquid flows into the second liquid, the tube comprising an inlet section comprising an inlet, a coiled section fluidically coupled to the inlet section, an outlet section fluidically coupled to the coiled section, and an outlet fluidically coupled to the outlet section, the tube adapted to maintain the bubbles of the oxygen-containing gas generated within the gas-enriched first liquid by the valve.

### BRIEF DESCRIPTION OF THE DRAWINGS

Various embodiments of the present invention together with arrangement given illustrative purposes only will now be described, by way of example only, and with reference to the accompanying drawings in which:

FIG. 1 depicts an apparatus for enriching a liquid with a gas and which is adapted to further introduce the enriched liquid-gas combination into a second liquid; and

FIGS. 2A-2E depict a tube, in accordance with an implementation.

### DETAILED DESCRIPTION

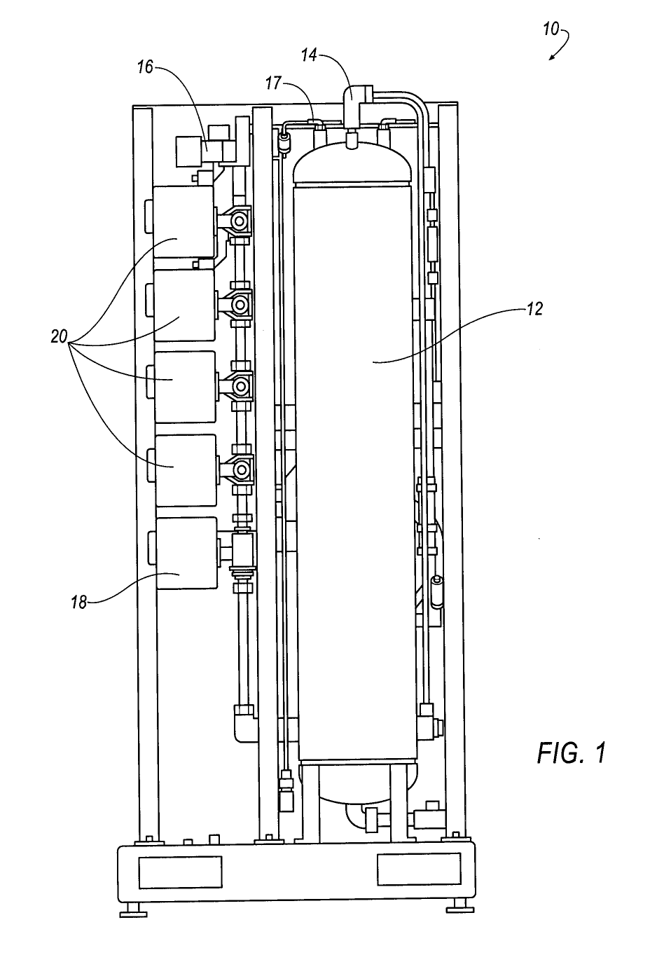

FIG. 1 depicts an apparatus 10 for enriching a liquid with a gas, and which is adapted to further introduce the enriched liquid-gas combination into a second liquid. The apparatus 10 is particularly well suited for enriching a liquid (for example, water or wastewater) with a gas (for example, oxygen or an oxygen-containing gas) to produce a gas-enriched liquid. In an implementation, the liquid enriched gas is enriched with oxygen, which can thereafter be introduced into a wastewater for the purpose of promoting the activity of aerobic microorganisms capable of biodegrading waste in the wastewater. In various implementations, the apparatus 10 can also be used to enrich liquids with other types of gases, for example, to enrich water or wastewater with ozone gas (O₃) to produce an emulsion of ozone gas-enriched liquid that can then be introduced into wastewater for the purpose of sterilization, or to enrich water or wastewater with nitrogen gas (N₂) to produce a nitrogen gas-enriched liquid that can then be introduced into water or wastewater for the purpose of nitrification. The invention should not be limited to the exemplary embodiments discussed herein and while examples have been provided to illustrate the enriched gas could be enriched with oxygen, ozone, nitrogen hydrogen and the like, other gases are contemplated as well.

In an implementation, the gas-enriched liquid contains the gas at sufficiently high levels to enable the subsequent generation of bubbles of the gas within the gas-enriched liquid. In an implementation, the apparatus 10 is adapted so that bubbles of a desired quantity and size are generated in a controlled manner within the gas-enriched liquid prior to the liquid being introduced into the second liquid (for example, wastewater).

With continued reference to FIG. 1, in an embodiment, the apparatus 10 comprises a pressurized vessel 12 and a fluid inlet 14 through which liquid to be enriched with the gas enters the vessel 12. In an embodiment, the liquid is atomized, for example, using an atomizing spray head of the type disclosed in Eppink. In an implementation, such a spray head (not shown) may be located within the vessel 12, which is pressurized with the desired enrichment gas (e.g. air or oxygen) to facilitate the absorption of the enrichment gas within the atomized liquid from the spray head. FIG. 1 represents the enrichment gas as being supplied to the vessel 12 through a valve 16 and supply tube 17. In the example where the enrichment gas is oxygen, the valve 16 supplies oxygen to the vessel 12 so that oxygen within the vessel 12 is at a sufficiently high pressure so that liquid introduced into the vessel 12 through the spray head becomes supersaturated with oxygen.

In an implementation, the gas-enriched liquid accumulates within the vessel 12 at a level within a prescribed range before being withdrawn from the vessel 12. The effect of maintaining the gas-enriched liquid at an appropriate level within the vessel 12 is to promote the ability of the atomized liquid to absorb and retain the enrichment gas. In an implementation, including the apparatus 10 of FIG. 1, the gas-enriched liquid is maintained within the vessel 12 at a volumetric level of substantially at or between 30 percent and 70 percent of the total internal volume within the vessel 12. Levels below this range may cause excessive off-gassing, and levels above this range may yield inadequate head space to complete gas absorption. A more preferred range is about 40 to about 60 volume percent, and a level of about fifty volume percent has proven to be effective as well.

In an implementation, the gas-enriched liquid is drawn from the vessel 12 through an analog valve 18 that has an opening (not shown) that can be selectively sized (i.e., provide a variable internal valve opening) between a completely closed state up to and including a maximum size for the opening. In an implementation, the valve 18 is operated so that its valve opening causes bubbles to be generated in the gas-enriched liquid as it is drawn from the vessel 12. As a non-limiting example, if oxygen is used as the enrichment gas, the gas-enriched liquid is water supersaturated with oxygen, and liquid flow through the valve 18 is at a rate of substantially at or between about 15-20 gallons/minute, the valve 18 can be partially opened to generate an effective volume fraction of bubbles in a size range of substantially at or between about 100 to about 200 micrometers in diameter. In an implementation, to optimize control of the volume fraction and size of the bubbles, the valve 18 is controlled with an electronic controller (not shown), which can use feedback from appropriate sensors (not shown) to control the volume fraction and size of the bubbles.

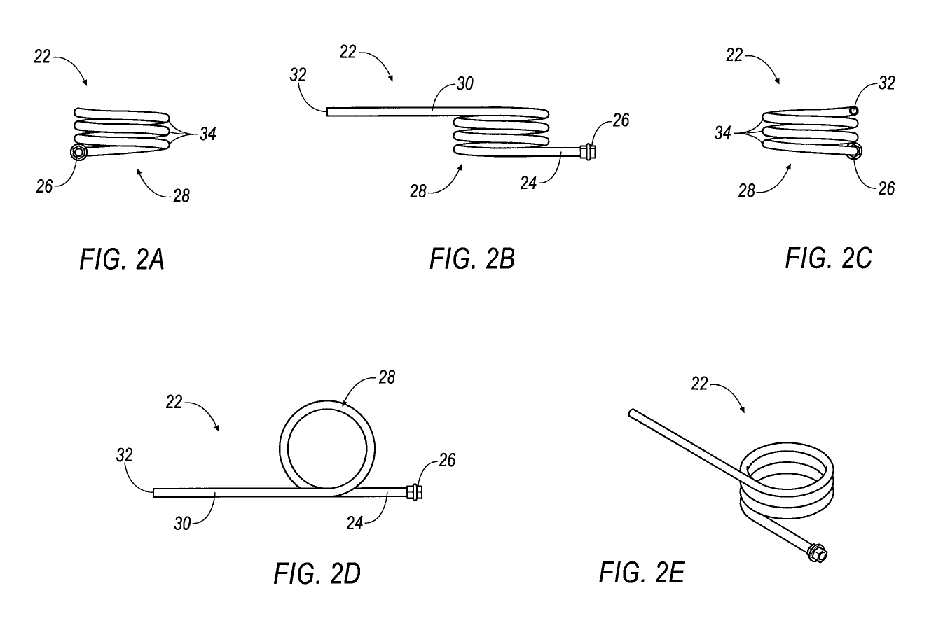

In an implementation, one or more zone valves 20 are provided downstream from the valve 18. After exiting the valve 18, the gas-enriched liquid containing the entrained bubbles can be delivered to various applications via the one or more of zone valves 20. In the example in which the enrichment gas is oxygen and the intended use of the gas-enriched liquid is to biodegrade waste in wastewater and create dense separation for decanting, the one or more zone valves 20 are used to route the gas-enriched liquid for introduction into one or more bodies or streams of wastewater (not shown) to promote the activity of aerobic microorganisms. To maintain the volume fraction and size of bubbles generated with the analog valve 18, the gas-enriched liquid and its entrained bubbles are introduced into the wastewater through a tube 22 of a type represented in FIGS. 2A-2E. In an implementation and as shown in FIGS. 2A-2E, the tube 22 comprises an inlet section 24, an inlet fitting 26 at the entrance to the inlet section 24 for fluidically coupling (directly or indirectly) the tube 22 to an outlet of the apparatus 10 (for example, one of the valves 20), a spiraled coil section 28, and an outlet section 30 that terminates with an outlet 32. In an implementation, the coil section 28 comprises three complete coils 34. In an implementation, each of the coil diameters are substantially equal. Non-equal coil diameters are contemplated hereby and the invention should not be so limited to three equal coil diameters. In an implementation, the inlet and outlet sections 26 and 30 are substantially straight and parallel to each other. The entire tube 22 preferably has a constant internal diameter.

In an implementation, the length and internal diameter of the tube 22 and the diameter and number of coils 34 within the coil section 28 are preferably selected so that flow of the gas-enriched liquid through the tube 22 is laminar which, in combination with surface friction within the coil section 28, is believed to maintain the entrainment of the bubbles in the gas-enriched liquid. For this purpose, suitable lengths and diameters for the tube 22, suitable numbers of coils 34, and suitable diameters for the coil section 28 will depend in part on the pressure and flow velocity of the gas-enriched liquid through the tube 22 and the saturation level of the gas in the liquid. In practice, suitable results have been obtained with an exemplary tube 22 having a total length of substantially at or between about 24 to about 48 inches and an internal diameter of larger than substantially at or between about 0.05 and 0.15 inches (e.g., at or about 0.10 inches), when used in combination with a coil section 28 having three coils 34 and a generally constant coil diameter of substantially at or between about 1.5 to about 2 inches.

While the disclosure hereof has described a method and product in n terms of a specific embodiment, it is apparent that other forms could be adopted by one skilled in the art. For example, the apparatus 10 and its components could differ in appearance and construction from the embodiment shown in the Figures, the functions of each component of the apparatus 10 could be performed by components of different construction but capable of a similar (though not necessarily equivalent) function, and various processes and materials could be employed to manufacture the apparatus 10 and its components. Accordingly, it should be understood that the invention is not limited to the specific embodiment illustrated in the Figures. It should also be understood that the phraseology and terminology employed above are for the purpose of disclosing the illustrated embodiment, and do not necessarily serve as limitations to the scope of the invention. Finally, while the appended claims recite certain aspects believed to be associated with the invention, they do not necessarily serve as limitations to the scope of the invention.

What is claimed is:

1. An apparatus for enriching a first liquid with a gas and introducing the gas-enriched first liquid into a second liquid, the apparatus comprising:
a vessel containing the gas at an elevated pressure;
a liquid fluid inlet into the vessel such that the first liquid enters the vessel and becomes enriched with the gas;
a variable internal valve defining an opening through which the gas-enriched first liquid flows after exiting the vessel, the internal valve opening selectively opened to generate bubbles of the gas within the gas-enriched first liquid as the gas-enriched first liquid flows therethrough; and
a tube through which the gas-enriched first liquid flows into the second liquid, the tube comprising an inlet section comprising an inlet, a coiled section fluidically coupled to the inlet section, an outlet section fluidically coupled to the coiled section, and an outlet fluidically coupled to the outlet section, the tube adapted to maintain the bubbles of the oxygen-containing gas generated within the gas-enriched first liquid by the valve means.

2. The apparatus according to claim 1, wherein the inlet and outlet sections of the tube are straight.

3. The apparatus according to claim 2, wherein the inlet and outlet sections of the tube are parallel.

4. The apparatus according to claim 1, wherein the coiled section of the tube has a constant coil diameter.

5. The apparatus according to claim 1, wherein the tube has a constant internal diameter.

6. The apparatus according to claim 1, wherein the tube has an internal diameter of substantially at or between about 1 mm and 4 mm.

7. The apparatus according to claim 1, wherein the gas is an oxygen-containing gas.

8. The apparatus according to claim 1, wherein the gas is a nitrogen-containing gas.

9. The apparatus according to claim 1, wherein the first liquid is water or wastewater.

10. The apparatus according to claim 1, wherein the second liquid is wastewater.

11. A process comprising:
causing a first liquid to become enriched with a gas;
generating bubbles of the gas within the gas-enriched first liquid; and flowing the gas-enriched first liquid and the bubbles therein into a second liquid through a tube, the gas-enriched first liquid flowing through, in sequence, an inlet section, a coiled section, an outlet section, and an outlet of the tube so as to retain the bubbles of the gas generated within the gas-enriched first liquid.

12. The process according to claim 11, wherein the inlet and outlet sections of the tube are straight.

13. The process according to claim 12, wherein the inlet and outlet sections of the tube are parallel.

14. The process according to claim 11, wherein the coiled section of the tube has a constant coil diameter.

15. The process according to claim 11, wherein the tube has a constant internal diameter.

16. The process according to claim 11, wherein the tube has an internal diameter of substantially at or between about 1 mm and 4 mm.

17. The process according to claim 11, wherein the gas is a nitrogen-containing gas.

18. The process according to claim 11, wherein the gas is an oxygen-containing gas.

19. The process according to claim 18, wherein the first liquid is water or wastewater.

20. The process according to claim 19, wherein the second liquid is wastewater and the gas-enriched first liquid promotes the activity of aerobic microorganisms capable of biodegrading waste in the wastewater.
